(19) United States
(12) Patent Application Publication
(10) Pub. No.: US 2005/0089326 A1
(43) Pub. Date: Apr. 28, 2005

(54) Cancellation of transmitted signal crosstalk in optical receivers of diplexer-based fiber optic transceivers

(76) Inventors: Zvi Regev, West Hills, CA (US); Schlomo Margalit, Chatsworth, CA (US)

Correspondence Address: GARY L. SHAFFER, 901 BANKS PLACE, ALEXANDRIA, VA, 22312, US

(21) Appl. No.: 10/956,361

(22) Filed: Oct. 4, 2004

Related U.S. Application Data
(60) Provisional application No. 60/507,968, filed on Oct. 3, 2003.

(51) Int. Cl. H04B 10/08

(52) U.S. Cl. 398/32

(57) ABSTRACT

Methods and devices for minimizing the crosstalk induced by optical leakage within fiber-optic transceivers are provided. Methods of the invention include wherein a pilot signal is generated and transmitted along with the other signals, and then used as a reference for evaluating the parameters of crosstalk when it occurs. The pilot signal is recognized and extracted from the received signals to manage control the process of crosstalk cancellation. Thus, when crosstalk occurs, samples of the transmitted signal are subtracted from the received signal so as to cancel out any residue of the transmitted signal found in the received signal.

### RELATED APPLICATIONS

The present application claims priority to U.S. Provisional Application No. 60/507,968, filed Oct. 3, 2003. The cited Application is hereby incorporated by reference in its entirety.

### FIELD OF THE INVENTION

This invention deals with crosstalk cancellation in communication channels, and in particular with crosstalk commonly induced by transmitted signals on optical receivers in optical diplexer-based fiber-optic transceivers.

### BACKGROUND OF THE INVENTION

High-speed signals are transmitted over fiber optic cables mainly because of the unique properties of the fiber-optic transmission medium, namely the inherent wide band of data transmission, and low attenuation through the fiber. Signals are transmitted over an optical fiber typically by means of amplitude modulation of a light wave carrier.

To save cost in installations, optical fibers are often utilized in bi-directional transmission over a single fiber, wherein optical signals are simultaneously transmitted over the same fiber in both directions. In typical prior art applications shown in FIG. 1, and 2, signals of the same wavelength are simultaneously transmitted in both directions over the fiber. In the implementation presented in FIG. 1, signal generated by a transmitter reaches the receiver on the other side of the optical fiber, but can also reach the receiver on the same side of the fiber as the transmitter. To avoid this kind of undesired signal reception, and also to allow both the transmitter and the receiver to cohabit the same pluggable transceiver module, an optical diplexer like the one presented in FIG. 2, is used. In the diplexer, an angled unidirectional mirror allows the light generated by the laser transmitter to pass through, and continue in a straight line towards the optical fiber. Light arriving through the fiber from the other side of the optical fiber does not pass through the mirror, and is deflected in an angle towards the optical receiver's photodiode. This method of transmission is problematic, however. More specifically, part of the light energy generated by the transmitter does not pass through and is deflected towards the receiver, thereby interfering with the light signal transmitted from the other side of the optical fiber, as is shown in FIG. 3. These undesired transmitted signals “leaking” through the optical diplexer and entering the receiver are known in the art as “crosstalk.” This invention deals with a method and a circuit to cancel out and eliminate the crosstalk signals.

### DESCRIPTION OF THE INVENTION

Intuitively, cancellation of undesired signals is possible by a summation of the unwanted signal, and another signal identical to the unwanted signal, but shifted in phase by 180°. Since both the laser transmitter, and the receiver affected by the crosstalk are housed in the same module, the signals transmitted by the laser transmitter, and eventually are leaking into the receiver and causing the crosstalk are known and available. Hence the received signal, which contains some signals that have leaked from the transmitter, can be summed up with the inverse of a sample of the transmitted signal. For full cancellation, the sample of the transmitted signal must be exactly the same magnitude as the magnitude of the leaked signal embedded in the received signal. The sample of the transmitted signal must also be phase shifted by exactly 180° with respect to the received crosstalk signal. In the circuit shown in FIG. 4, a sample of the transmitted signal is negated, converted into current and summed up with the signal current generated by the receiver photodiode at the input to the receiver's transimpedance amplifier. Since the cancellation of crosstalk requires that the sample of the transmitted signal will be phase shifted by precisely 180°, a variable delay device is inserted following the signal negation. This delay is required to account for the delay the “leaking” signal accrues as it passes through the laser transmitter. This delay must be variable as the exact delay in the leaking signal path is unknown, and the variable delay must be adjusted to precisely account for the accrued delay. The magnitude of the “canceling” current must be exactly equal to that of signal current caused by the crosstalk signal. The control over the magnitude of the canceling current is achieved by the combination of a variable gain amplifier followed by a resistor. The current through the resistor is the voltage at the output of the amplifier divided by the resistance of the resistor. The gain of the amplifier is adjusted such the crosstalk signal is eliminated, from the received signal at the output of the receiver.

One obvious problem is how to identify the crosstalk signal in the received signal. In order to be able to identify the crosstalk signal it must carry a specific marker that is added to the transmitted signal, such that when it leaks into the receiver, it could be identified. Such marker must not interfere with the transmitted or the received signals. It should also allow independent observation of the effects of phase and magnitude variations in the sample of the transmitted signals on the cancellation of the crosstalk signals.

Signals transmitted over optical fibers are typically high frequency in nature, and typically the lowest frequency transmitted is in the order of several hundreds of megahertz. Lower frequency signals can thus be used to control the crosstalk cancellation. To minimize the effect of the marker signal on the transmitted or the received signals, and to allow easy identification of the marker, this marker signal also known a pilot signal must occupy a very small frequency bandwidth. To enable independent monitoring on the effects of the phase, and the magnitude adjustments, the pilot signal is to contain two signals, which are exclusively independent, such as two sine waves of harmonically independent frequencies.

Having a pilot signal transmitted along with the normally transmitted high frequency signals, allows automatic control over the crosstalk cancellation process, as shown in FIG. 5. To independently control the phase and the magnitude, two special low frequency signals are generated and combined as a pilot signal and transmitted along with the high frequency signals over the optical fiber. The signals received in the receiver are comprised of the high frequency signals, the high frequency crosstalk signals, and the low frequency pilot signal. It is assumed that the frequency bandwidth of the transceiver is very large, and therefore the pilot signal, transmitted along with the high frequency signals is delayed through the transmitter exactly the same delay as the high frequency signals. In the receiver the pilot signal can be separated from the high frequency crosstalk signal simply by means of a low pass filter, as shown in FIG. 5. The two components of the pilot signal are completely independent of each other, and each has some unique properties so that it can be readily separated and used independently. One signal is used in a phase locked loop, comprised of the variable phase shifter, the variable gain amplifier, the series resistor, the optical receiver, and the low-pass filter, to control the delay in the variable delay device to achieve precise 180° phase shift in the canceling signal path. The other signal is used in a peak detector to measure the magnitude of that signal at the output of the receiver. The output of the peak detector is used to control the gain of the variable gain amplifier, and the magnitude of the canceling signal current, such that the magnitude of the pilot signal at the peak detector is minimized.

There may be several ways by which the pilot signal received in the receiver is utilized to control the phase and magnitude of the sample pilot signal, such that the crosstalk is minimized. One such method is shown in FIG. 8, using a micro-controller. The micro-controller can be implemented in many ways, and employ various algorithms as to control the phase and the magnitude of the sample of the pilot signal in order to minimize the crosstalk.

In one simple method, an iterative process is used, similar to a method known in the art of numerical solutions for equations, as the Newton-Raphson method to determine the root of an equation. Let the composite signal to be transmitted be X(t), and the transmitted signal leaked to the receiver αX(t)+βT, wherein α<<1 is the attenuation factor between the transmitted signal and the leaked signal, and βT is the time delay in the leaking signal from the transmitter to the receiver. To cancel out the leaking signals a signal is added at the input to the optical receiver such that {[αX(t)+βT]−[AX(t)+BT]}=0. A, and B, are the unknown roots of the equation that needs to be found such that the equation will be satisfied. It is clear that if A=α, and B=β, then the equation is true. According to this method, the micro-controller repeatedly measures the magnitude of the pilot signal at the output of the receiver, which is desired to be zero. Consequently the micro-controller, via a digital to analog converter changes the gain of the variable gain amplifier, while monitoring the magnitude of the pilot signal in the receiver. If the change in the gain of the amplifier increases the magnitude of the received pilot signal, the direction of the change in the gain of the amplifier is reversed. If the change in the gain reduces the magnitude of the received pilot signal, the gain is again changed in the same direction, and the process is repeated until a change in the gain does not result in a reduction of the magnitude of the received pilot signal. Then the controller reverts to change the phase shift in the variable phase shifter. A process similar to the one involving the gain change is pursued with repeated phase shift, until the phase shifts do not reduce the received pilot signal. The controller reverts back to changing the gain, and then to changing the phase, until any change does not cause a reduction in the received pilot signal, which at this point is considered minimized.

In a different embodiment shown in FIG. 7, an analog control system is utilized. In this system two harmonically independent low frequency sinewaves are the basis for the pilot signal. These two signals are separately mixed with two quadrature samples of a third frequency, in order to generate two higher frequencies, each comprised of a carrier, AM modulated by one of the two low frequency sine waves, and wherein the carriers are in quadrature of each other. These two signals are combined together to form the pilot signal. The reason for the mixing is to generate a very narrow bandwidth, in close proximity to the lowest frequency normally transmitted by the laser transmitter. The reason for having the two signals comprising the pilot signal in quadrature of each other is that when one signal is minimized in the process, the other is not as it is phase shifted by 90°, and thus can still be used to control the second parameter.

In the receiver the pilot signal is separated from other received signal by means of a filter. As the pilot signal is a very narrow-band signal, a narrow-band filter rejects all unwanted signals, and noise as well. The filtered out pilot signal is down converted by a mixer, using the same frequency as is used in the up conversion in the transmitter, as a result, two low frequency signals are recovered. The magnitude of these signals needs to be measured and monitored. There are numerous way of measuring the magnitude. One simple method is using synchronous detection, wherein two signals of the same frequency are multiplied, as

$$( A sin X ) ( B sin X ) = \frac{1}{2} A B [ - cos ( X + X ) + cos ( X - X ) ] .$$

The first component in the equation is

$$- \frac{1}{2} A B cos ( X + X ) = - \frac{1}{2} A B cos 2 X$$

which is a component at twice the frequency X, which is eliminated using a low-pass filter. The second component in the equation

$$\frac{1}{2} A B cos ( X - X ) ,$$

is a DC component which depends only on the magnitudes of A and B. In the receiver each of the two low frequency components of the pilot signal, is multiplied with the signal of the same frequency used in the transmitter to generate the pilot signal. The low frequency signals in the transmitter have a stable and fixed amplitude A, therefore, the magnitude of the DC component that results from the multiplication depends only on the magnitude B of the received pilot signal. These two DC signals, generated by multiplying the two low frequency signals in the pilot signal, are used to control the phase shifter, and the gain, as to yield the minimum magnitude for the received pilot signal. As the pilot signal is transmitted along with the normal high frequency signals, and appears in the crosstalk signal just like the high frequency signals. Therefore, the cancellation or minimization of the received pilot signal is indicative of the minimization or cancellation of all the crosstalk signals.

### DESCRIPTION OF THE DRAWINGS

FIG. 1, shows conventional bi-directional communication over a single optical fiber.

FIG. 2, shows a conventional optical diplexer adapted to allow bi-directional communication over a single fiber-optic cable.

FIG. 3, shows the optical leakage in a conventional optical diplexer.

FIG. 4, shows an embodiment of a circuit of the invention which is adapted for canceling crosstalk signals in an optical transceiver

FIG. 5, shows an embodiment of a circuit of the invention adapted for automatic cancellation of crosstalk signals in an optical transceiver.

FIG. 6, shows exemplary components of a pilot signal according to the invention, and their use in controlling crosstalk.

FIG. 7, shows another embodiment of a circuit of the invention adapted for the automatic cancellation of crosstalk signals in an optical transceiver.

FIG. 8, shows yet an additional different embodiment of a circuit of the invention adapted for the automatic cancellation of crosstalk signals in an optical transceiver

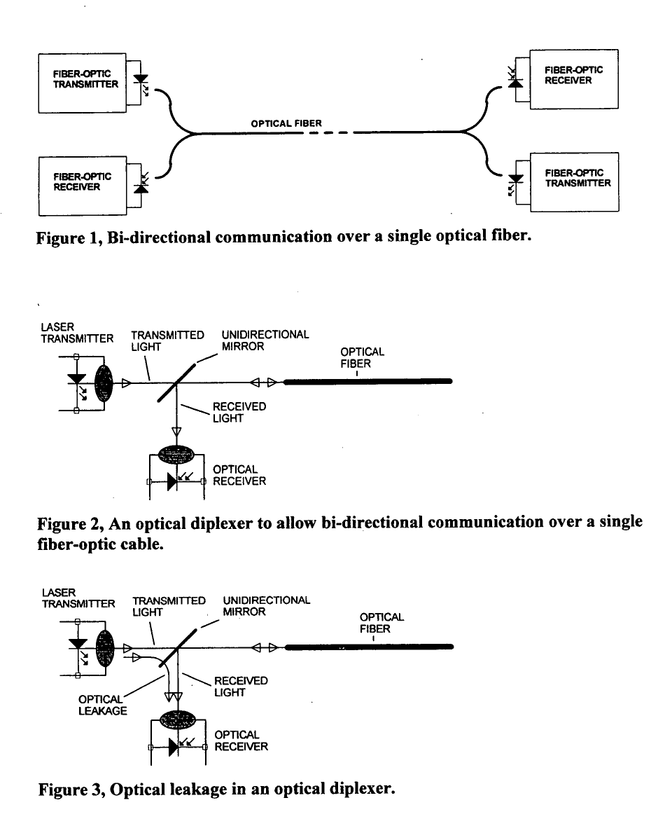

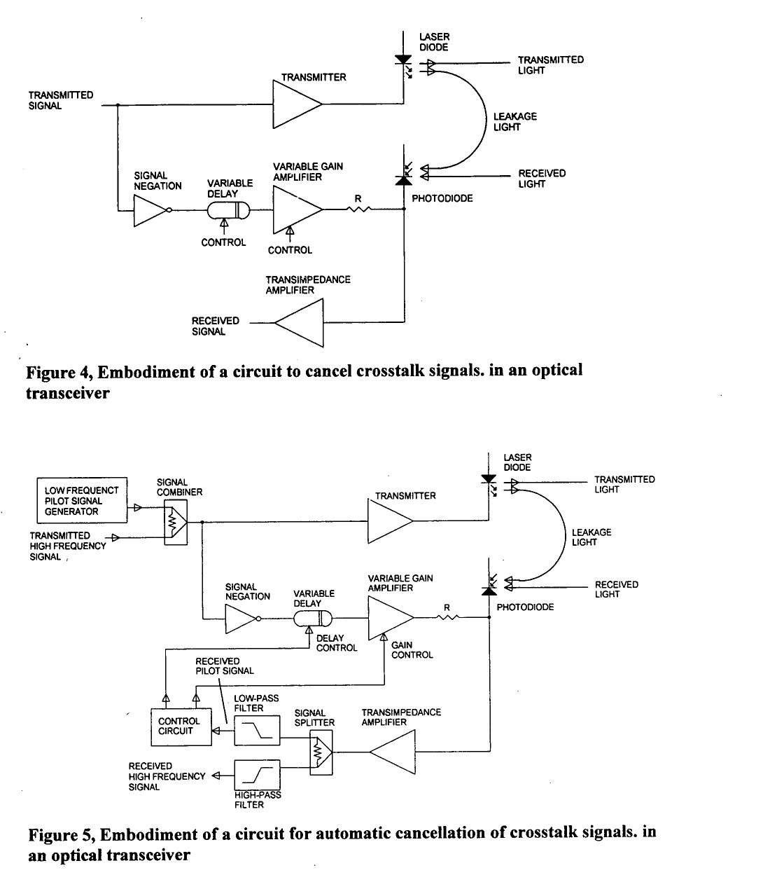

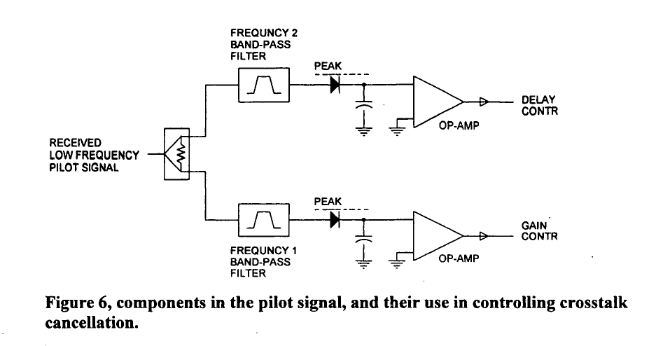

### DETAILED DESCRIPTION OF THE INVENTION

In the following detailed description, reference is made to the accompanying drawings, which form a part hereof, and in which are shown by way of illustration of specific embodiments in which the invention may be practiced. These embodiments are described in sufficient detail, to enable those of ordinary skill in the art, to make and use the invention. It is to be understood that structural, logical or procedural changes may be made to the specific embodiments disclosed without departing from the spirit and scope of the present invention.

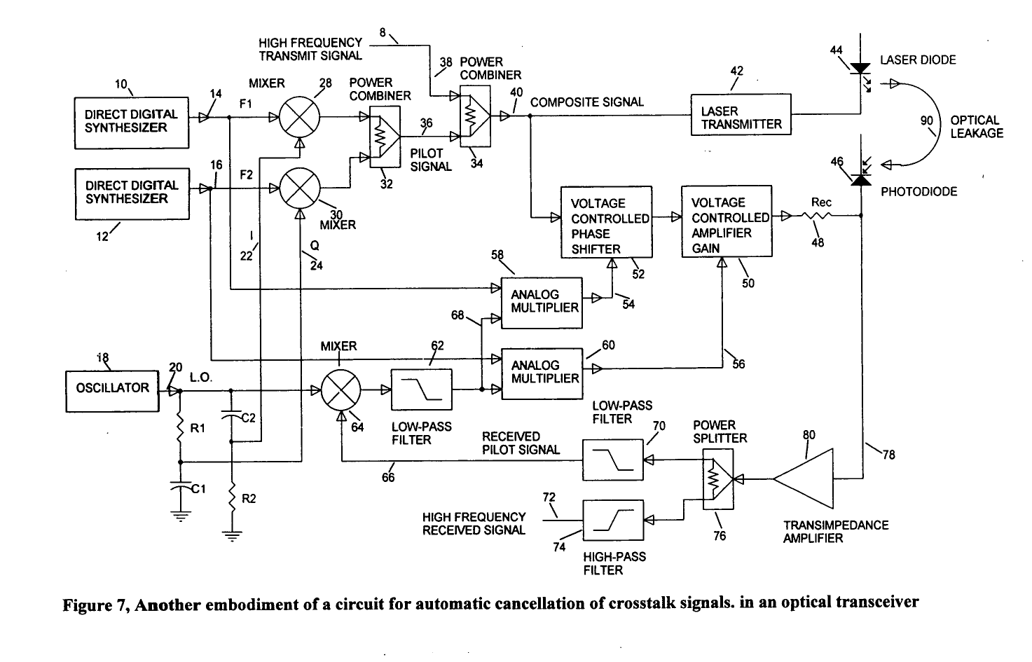

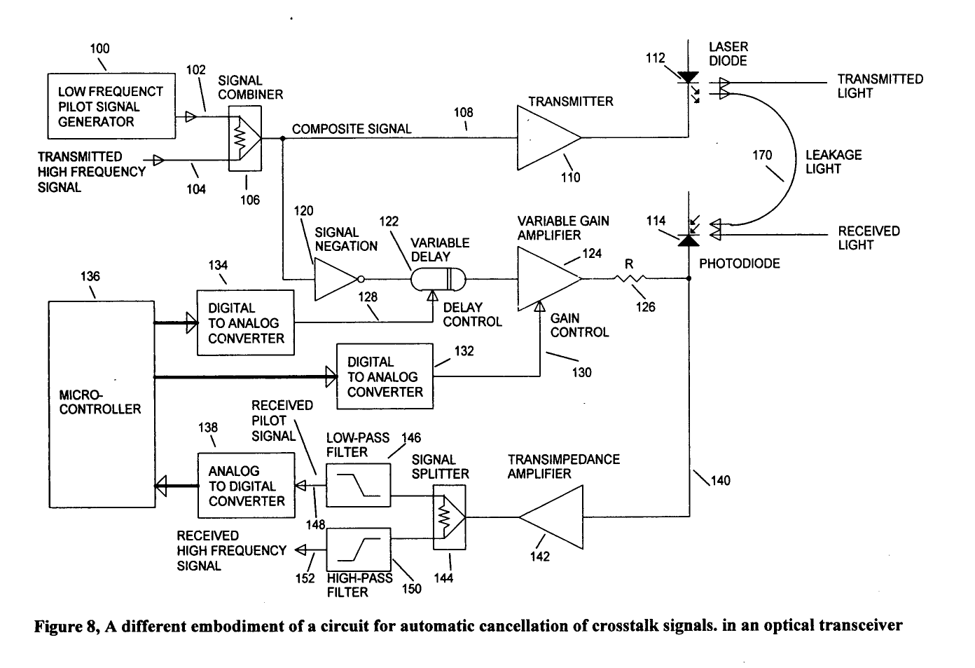

Detailed block diagrams of two embodiments of the invention are shown in FIGS. 7, and 8. Due to optical leakage 90, a portion of the transmitted optical signals appear in the receiver, and causes “crosstalk” interference with the signals generated remotely and transmitted over an optical fiber to the optical receiver. This invention describes a method and a circuit, to cancel out the products of the leakage, and eliminate the crosstalk.

In the embodiment presented in FIG. 7, two Direct Digital Synthesizers (DDS), 10 and 12, are used to generate two low frequency, harmonically independent sinewaves, at frequencies F1 14, and F2 16. A radio frequency oscillator 18, generates an L.O. signal 20 at a frequency lower than the lowest frequency component in the high frequency signal 8, destined to be transmitted by the laser transmitter 42. A network of resistors R1, R2, C1, and C2, converts the L.O. signal 20, into two signals I 22, and Q 24, which are in quadrature to each other, meaning that Q 24, is phase shifted by 90° with respect to I 22. The signals I 22, and Q 24, are connected to two RF mixers 28, and 30, respectively. The operation of the mixers does not need to be discussed here, as these are devices readily known to those skilled in the art of radio frequency operations. The mixer 28, is also connected to the signal F1 14, while the mixer 30 is also connected to the signal F2 16. As a result, the output of the mixer 28 is sin2ΠF1(sin2ΠF_{LO}), and the mixer 30 generates an output signal sin

$$sin 2 Π F 1 ( sin 2 Π {F}_{LO} + \frac{Π}{2} ) .$$

The output signals of both mixers 28 and 30 are combined together in the power combiner 32, to yield the pilot signal 36. In the power combiner 34, the pilot signal 36 is combined with the high frequency transmit signal 8, to generate the composite signal 40. The combined composite signal 40 is to be transmitted by the laser transmitter 42, with the knowledge that a small part of this composite signal will leak into the optical receiver 80.

The composite signal 40 is also applied to a voltage controlled phase shifter 52, which is controlled by the control signal 54. The output of the phase shifter 52 is connected to an amplifier 50 whose gain is controlled by a voltage signal 56. The output the voltage controlled amplifier 50 is connected to a large resistor R_{EC} 48 which is connected on its other side to the junction 78 of the optical receiver's photodiode 46, and the input to the transimpedance amplifier 80.

Optical signals are received in the optical receiver comprised of the photodiode 46, and the transimpedance amplifier 80. These signals are comprised of light generated by a remote optical transmitter and transmitter via an optical fiber, as well as a small portion of light generated by the laser transmitter comprised of the transmitter 42 and the laser diode 44, and leaked to the optical receiver. This leakage signal is the undesired signal, which causes crosstalk distortions, and needs to be cancelled out.

The signal transmitted by the laser transmitter 42 is a composite signal comprised of a high frequency signal 8, and a pilot signal 36. The optical leakage signal received by the photodiode 46 is comprised of the same two signals. Before the cancellation process goes into effect, this composite leakage signal is amplified by the transimpedance amplifier 80, and applied to the power splitter 76, which splits the received signal in two, and sends it to two filters. The high-pass filter 74 passes only the high frequency signals 72, and the low-pass filter 70 which passes only the lower frequency pilot signal 66. The received pilot signal 66 connects to another RF mixer 64, which also connects to the L.O. signal 20, generated by the oscillator 18. The mixer 64 receiving the pilot signal 66, and the L.O. signal 20, generates two signals, one which is the sum of the pilot signal 66 and the L.O. signal 20, and the second one which is the difference between the pilot signal 66 and the L.O. signal 20. The output of the mixer 64 connects to a low-pass filter 62, which passes only the signal which is the difference between the pilot signal 66, and the L.O. signal 20. The output signal 68 from the low-pass filter connects to two analog multipliers 58 and 60, respectively.

The pilot signal 36 in the transmitter is generated by mixing the low frequency signals F1 14, and F2 16, with the L.O. signals 22 and 24 respectively. Thus, mixing the pilot signal 66 in the receiver, with the L.O. signal 20, recovers the two low frequency signals at the frequencies of F1, and F2 respectively. Since the mixing process in the mixers 28 and 30 is done with two signals, I 22, and Q 24, which are in quadrature, the two signals comprising the recovered signal 68 are in quadrature as well.

In the analog multiplier 60, the input signal 68 is multiplied by the low frequency signal F2 16. The component in the input signal 68, which is in the frequency of F2, interacts in the multiplier 60 with the input signal F2 16. For

$$( A sin X ) ( B sin Y ) = \frac{1}{2} A B [ - cos ( X + Y ) + cos ( X - Y ) ] ,$$

and for X=Y, then

$$( A sin X ) ( B sin X ) = \frac{1}{2} A B [ - cos ( X + X ) + cos ( X - X ) ] .$$

The first component in the equation is

$$- \frac{1}{2} A B cos ( X + X ) + - \frac{1}{2} A B cos 2 X$$

which is a component at the frequency 2X or twice the frequency X, which is eliminated using a low-pass filter, and the last component in the equation

$$\frac{1}{2} A B cos ( X - X ) = \frac{1}{2} A B cos 0 = \frac{1}{2} A B ,$$

is a DC component which depends only on the magnitudes of A and B.

Assuming that A is the magnitude of the F2 16 signal, and B is the magnitude of the F2 component in the input signal 68, which depends on the magnitude of the leakage of the pilot signal in the receiver. The output 56 of the multiplier 60 controls the amplifier 50. The amplifier is controlled such that the voltage at the output of the amplifier 50, when divided by the resistance of the resistor R_{EC} 48, yields a current that subtracts from the current generated by the optical leakage 90 arriving on the photodiode 46, as to minimize the magnitude B, of the pilot signal received. Thus, the closed loop comprising of the amplifier 50, the resistor 48, the transimpedance amplifier 80, the power splitter 76, the low-pass filter 70, the mixer 64, the low-pass filter 62, and the analog multiplier 60, operates such as to minimize the magnitude B of the received pilot signal 66.

In the analog multiplier 60, the input signal 68 is multiplied by the low frequency signal F1 14. The component in the input signal 68, which is in the frequency of F1, interacts in the multiplier 60 with the input signal F1 14. The output 54 of the multiplier 56 controls the phase shift in the voltage controlled phase shifter 52. The control voltage 54 controls the phase shift in the phase shifter 52 to be around 180°, such that in the close loop comprising of the amplifier 50, the resistor 48, the transimpedance amplifier 80, the power splitter 76, the low-pass filter 70, the mixer 64, the low-pass filter 62, and the analog multiplier 58, operates such as to minimize the magnitude B of the received pilot signal 66.

The magnitude B of the received pilot signal 66 is indicative of the residue of the optical leakage present in the received signal. As B is minimized, optimally to zero, so is the effect of the optical leakage signal, on the signals received in the optical receiver, and thus canceling the crosstalk effect.

Another embodiment is presented in FIG. 8. In this embodiment, a pilot signal generator 100 generates a pilot signal 102, which is combined with the high frequency signal 104 in the combiner 106, to yield a composite signal 108. The composite signal excites the laser transmitter, comprised of the transmitter 110, and the laser diode 112. Optical signals generated by the laser diode 112 generates, in response to the excitation by the composite signal, an optical signal transmitted via an optical fiber. Some of the optical signal generated by the laser diode 112, also reaches the photodiode 114, in the form of a leakage signal 170, and interferes with other signals arriving at the photodiode 114 via the optical fiber.

The composite signal 108 is also applied to the signal negator 120. The output of the signal negator 120 connects to the voltage controlled phase shifter 122, which is controlled by the control signal 128. The output of the phase shifter 122 connects to a variable gain amplifier 124, whose gain is controlled by the control signal 130. The output of the variable gain amplifier 124 connects to a large resistor R 126 which converts the voltage at the output of the amplifier 126 into current at the node 140, between the photodiode 114, and the input to the transimpedance amplifier 142. The output of the transimpedance amplifier 142 connects to the signal splitter 144, which splits the signals at the output of the amplifier 142, into two identical copies. One of the two signals generated by the splitter 144 is applied to the high-pass filter 150, and the other is applied to the low-pass filter 146. The output 152 of the high-pass filter is the high frequency signal 152. The output 148 of the low-pass filter 146 is the pilot signal that had leaked into the receiver, and is applied to the analog to digital converter 138, which converts the amplitude of the pilot signal that had leaked into the receiver into digital data applied to the micro-controller 136.

The micro-controller 136 connects to two digital to analog converters (DAC), 132, and 134, respectively. The DAC 132 generates a voltage 130 that controls the gain of the amplifier 124. The DAC 134 generates a voltage 128 that controls the phase shift in the phase shifter 122. The micro-controller 136 monitors the data it receives from the ADC 138. The controller 136 applies algorithms and programs to control the gain of the amplifier 124, and the phase shifter 122, such that the magnitude of the pilot signal at the output of the transimpedance amplifier 142, will be minimized or eliminated all together.

While the invention has been described in detail in connection with preferred embodiments known at the time, it should be readily understood that the invention is not limited to the disclosed embodiments. Rather, the invention can be modified to incorporate any number of variations, alterations, substitutions or equivalent arrangements not heretofore described, but which are commensurate with the spirit and scope of the invention.

1. A fiber-optic transceiver comprising:
at least one optical transmitter;
at least one optical receiver;
at least one optical diplexer;
at least one pilot signal generator in the transmitter;
at least one means to detect the pilot signal in the receiver;
at least one means to reduce the effects of crosstalk in the receiver; and
at least one single optical fiber utilized to carry optical signal generated by the optical transmitter to a remote optical receiver and to carry optical signals generated by a remote optical transmitter to the optical receiver in the transceiver.

2. An optical transceiver as in claim 1 wherein part of the optical signals generated by the optical transmitter leaks through to the optical receiver and wherein an electronic circuit is employed to minimize eliminate or cancel the effects of the leaking optical signal.

3. An optical transceiver as in claim 1 wherein crosstalk interference induced by optical leakage from the transmitter to the receiver is reduced by means of subtracting a sample of the transmit signals from the received signal.

4. An optical transceiver as in claim 3 wherein a pilot signal is generated combined with other signals and transmitted as composite signal by the transmitter.

5. An optical transceiver as in claim 3 wherein a replica of the pilot signal as in claim 4 is utilized to control and minimize the effect of crosstalk caused by signals induced in the receiver by leaking optical signals.

6. A fiber-optic transceiver comprising:
at least one optical transmitter;
at least one optical receiver;
at least one optical diplexer;
at least one pilot signal generator in the transmitter;
at least one means to detect the pilot signal in the receiver;
at least one means to reduce the effects of crosstalk in the receiver; and
at least one single optical fiber utilized to carry optical signal generated by the optical transmitter to a remote optical receiver and to carry optical signals generated by a remote optical transmitter to the optical receiver in the transceiver.

7. An optical transceiver as in claim 6, wherein part of the optical signals generated by the optical transmitter leaks through to the optical receiver.

8. An optical transceiver as in claim 6, wherein crosstalk interference induced by optical leakage from the transmitter to the receiver is reduced by means of subtracting a sample of the transmit signals from the received signal.

9. An optical transceiver as in claim 8, wherein a pilot signal is generated combined with other signals and transmitted as composite signal by the transmitter.

10. An optical transceiver as in claim 8, wherein a replica of the pilot signal as in claim 17 is utilized to control and minimize the effect of crosstalk caused by signals induced in the receiver by leaking optical signals.

11. An optical transceiver as in claim 8, wherein the pilot signal as in claim 16 comprises of two harmonically independent low frequency signals each mixed with one of two other signal both of the same third frequency but phase shifted by 180° with respect to each other and wherein the mixing process produces two other signals and further wherein one signal is the third frequency AM modulated by the first frequency and the second signal is the third frequency AM modulated by the second frequency and further wherein the two AM modulated signals are combined together to generate a pilot signal.

12. A fiber-optic transceiver comprising:
at least one optical transmitter;
at least one optical receiver;
at least one optical diplexer;
at least one pilot signal generator in the transmitter;
at least one means to detect the pilot signal in the receiver;
at least one means to reduce the effects of crosstalk in the receiver;
at least one micro-controller; and
at least one single optical fiber utilized to carry optical signal generated by the optical transmitter to a remote optical receiver and to carry optical signals generated by a remote optical transmitter to the optical receiver in the transceiver.

13. An optical transceiver as in claim 12, wherein part of the optical signals generated by the optical transmitter leaks through to the optical receiver and wherein an electronic circuit is employed to minimize eliminate or cancel the effects of the leaking optical signal.

14. An optical transceiver as in claim 12, wherein crosstalk interference induced by optical leakage from the transmitter to the receiver is reduced by means of subtracting a sample of the transmit signals from the received signal.

15. An optical transceiver as in claim 12, wherein a micro-controller is used the monitor and control the means to reduce the crosstalk in the receiver.

16. An optical transceiver as in claim 12, wherein a pilot signal is generated combined with other signals and transmitted as composite signal by the transmitter.

17. An optical transceiver as in claim 12, wherein a replica of the pilot signal as in claim 16, induced in the receiver by leaking optical signals as in claim 13 is utilized to control and minimize the effect of crosstalk caused by signals induced in the receiver by leaking optical signals.

18. An optical transceiver as in claim 12, wherein a sample of a composite signal generated in the transmitter comprising of a high frequency signal and a pilot signal is generated by the transmitter and supplied to the receiver via a variable delay and a variable voltage controlled current source.

19. An optical transceiver as in claim 12, wherein current generated in response to the inverse of samples of the transmitted composite signal is summed in the optical receiver with current generated in the receiver by the photodiode in response to optical signals received by the photodiode.

20. An optical transceiver as in claim 18, wherein the variable delay is controlled as to cause the current generated in response to a sample of the composite signal to be shifted by exactly 180° with respect to current generated in the optical receiver by leaking optical signals.
